(19) United States
(12) Patent Application Publication
(10) Pub. No.: US 2009/0284685 A1
(43) Pub. Date: Nov. 19, 2009

(54) LIQUID CRYSTAL DISPLAY MODULE, WAVELENGTH DISPERSIVE DIFFUSION SHEET AND LIQUID CRYSTAL DISPLAY DEVICE

(75) Inventor: Hiroshi Yamaguchi, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Kadoma-shi, Osaka (JP)

(21) Appl. No.: 12/296,388

(22) PCT Filed: Apr. 17, 2007
(86) PCT No.: PCT/JP2007/058366

§ 371 Date: Oct. 7, 2008

(30) Foreign Application Priority Data
Apr. 17, 2006 (JP) 2006-113145

(51) Int. Cl. G02F 1/13357; G02B 5/02

(52) U.S. Cl. 349/64; 359/599

(57) ABSTRACT

A liquid crystal display module is provided to reduce a color shift. The liquid crystal display module is comprised of a liquid crystal panel in which the transmittance for incident illumination light has wavelength dependency that is different in both an incident angle and a wavelength, a light source for illuminating the liquid crystal panel from its back surface, and a wavelength dispersive diffusion sheet set between the liquid crystal panel and the light source, wherein the wavelength dispersive diffusion sheet has a characteristic to ease wavelength dependency of the liquid crystal panel.

### TECHNICAL FIELD

The present invention relates to a liquid crystal display module, wavelength dispersive diffusion sheet, and liquid crystal display apparatus.

### BACKGROUND ART

Thin, lightweight liquid crystal display apparatuses capable of image display have rapidly become widespread due to price reductions and the development of high-image-quality technology resulting from advances in manufacturing techniques, and are widely used in personal computer monitors, TV receivers, and the like.

A transmission liquid crystal display apparatus is generally used as a liquid crystal display apparatus. A transmission liquid crystal display apparatus is equipped with a planar light source called a backlight, illumination light from which is spatially modulated by a liquid crystal panel and forms an image.

One problem in terms of the performance of such a liquid crystal display apparatus is the “color shift” phenomenon whereby colors vary according to the observation direction. This is due to the fact that there is angular dependency in the transmittance of a liquid crystal panel, and there is also anisotropy in wavelength dependency (wavelength dispersion characteristic). Another problem is anisotropy in backlight light distribution.

FIG. 1 shows the results of measuring a horizontal (liquid crystal panel horizontal-direction) light distribution characteristic when the single colors red, blue, and green are displayed by a liquid crystal display apparatus that uses TN liquid crystal. It can be seen that long-wavelength red light shows a relatively wide light distribution profile, while short-wavelength blue light shows a relatively narrow light distribution profile.

FIG. 2 shows the results of evaluating a light distribution characteristic via red, green, and blue color filters when the liquid crystal display apparatus used for the FIG. 1 measurements is removed and the backlight is lit. As can be seen from FIG. 2, no particular wavelength dispersion characteristic is perceived in illumination light from the backlight, and it is evident that the pronounced wavelength dispersion characteristic perceived in FIG. 1 is due to the characteristics of the liquid crystal panel.

As a result of the above light distribution characteristic, when a screen displaying white is observed, it appears bluish from a relatively frontal direction and reddish from a direction at a large angle (a diagonal direction). FIG. 3 is a schematic diagram showing the state of color shift occurrence when a liquid crystal panel is illuminated by a general light source with no wavelength dispersion.

FIG. 4 is a drawing showing color variation (color shift) of a white display of a liquid crystal display apparatus according to the observation angle, plotted as a chromacity locus on a CIE chromacity diagram. As can be seen from FIG. 4, colors on the chromacity coordinates vary approximately in line with a black body radiation locus. That is to say, there is great variation in chromacity according to the observation angle, while there is almost no variation in deviation duv. From the above, it is determined that chromacity can be used as a unified quantification indicator of the above color shift phenomenon. Since a chromacity coordinate indication requires two dimensions, x and y, while the light distribution characteristic indication in FIG. 1 requires three dimensions, red, blue, and green, the former is more convenient than the later.

FIG. 5 is a graph showing the color shift of the white display shown in FIG. 4 as a relationship between the observation angle (measurement angle) and color temperature. In FIG. 5, the horizontal axis represents the measurement angle and the vertical axis represents the color temperature. When the liquid crystal panel is viewed from the front, a bluish tint is relatively pronounced and the color temperature relatively high. As the observation angle becomes wider, the reddish component increases and the color temperature becomes lower.

Methods that have been proposed in order to lessen the above color shift phenomenon are to use light sources of each of the three primary colors and make these incident on a light-guide-plate-side surface with a different light distribution characteristic, or to use a white light source make light emitted from a light guide plate incident on a liquid crystal panel via a hologram with a different output angle according to the wavelength (see Patent Document 1).

Patent Document 1: Japanese Patent Application Laid-Open No.2004-61693

### DISCLOSURE OF INVENTION

### Problems to be Solved by the Invention

However, with the method whereby light sources of each of the three primary colors are used and these are made incident on a light-guide-plate-side surface with a different light distribution characteristic, there is a problem of a tendency for color unevenness to occur.

A light guide plate repeatedly fully reflects light incident from an end surface between main surfaces toward the end surface opposite the incident end, and emits part of that light by means of a diffusion section provided on one opposing main surface or a diffusion member dispersed within the light guide plate.

In order to obtain uniform illumination from the entire surface of the light guide plate, it is necessary to set the formation density and pattern size distribution of the diffusion section, and the diffusion density distribution of the diffusion member, appropriately. However, the light propagation and emission situation varies according to the light distribution pattern of the light. Specifically, when light distribution of incident light is wide, the proportion of light emitted from the vicinity of the incident surface of the light guide plate is large, the incident side of the light guide plate is bright, and the opposite side is dark. Conversely, when the directivity of incident light is sharp, the incident side of the light guide plate is dark, and the opposite side is bright.

For example, when the light distribution pattern of blue light is widened relatively at a certain relative light intensity and is incident on the light guide plate, as in the implementation example of Patent Document 1, color unevenness occurs, with the vicinity of the incident side of the light guide plate becoming bluish, and the opposite side reddish.

Therefore, a difficulty with the method whereby the light distribution pattern is varied lies in reconciling lessening of the observation angle related color shift phenomenon with achievement of a uniform display showing no color unevenness over the entire screen.

Meanwhile, there is also a method whereby a white light source is used, and different directivities are provided for red, blue, and green, using three hologram sheets that diffuse light of specific wavelengths after light is emitted from the light guide plate. A problem with this method is that, while intra-screen uniformity and light distribution characteristic display control can be performed independently, the use of three hologram sheets makes the apparatus correspondingly thick and the price correspondingly higher.

The present invention has been implemented taking into account the problems described above, and it is an object of the present invention to provide a liquid crystal display module, wavelength dispersive diffusion sheet, and liquid crystal display apparatus that reduce the occurrence of color unevenness and offer an accurate display with little color variation due to the observation angle by means of an extremely simple configuration.

### Means for Solving the Problems

A liquid crystal display module of the present invention is equipped with a liquid crystal panel having wavelength dependency whereby transmittance for incident illumination light differs according to both the incident angle and wavelength of illumination light, a light source that illuminates the liquid crystal panel from the back surface, and a wavelength dispersive diffusion sheet that is located between the liquid crystal panel and light source and has wavelength dependency; wherein the wavelength dispersive diffusion sheet has a characteristic whereby wavelength dependency lessens the wavelength dependency of the liquid crystal panel.

With a wavelength dispersive diffusion sheet of the present invention, within a transparent base material, fine fibers that are approximately circular in cross-section and have a refractive index different from the base material are dispersed oriented so that their lengthwise directions approximately coincide.

A liquid crystal display apparatus of the present invention has a liquid crystal panel having wavelength dependency whereby transmittance for incident illumination light differs according to both the incident angle and wavelength of illumination light, a wavelength dispersive diffusion sheet that is located between the liquid crystal panel and a light source that illuminates the liquid crystal panel from its back surface, and has wavelength dependency, and whose wavelength dependency is set so as to lessen the wavelength dependency of the liquid crystal panel, and a display control circuit that drives the liquid crystal panel and displays an image.

### Advantageous Effect of the Invention

According to the present invention, it is possible, with a simple configuration, to correct wavelength dependency whereby the transmittance for incident illumination light differs according to both the incident angle and wavelength of illumination light, and perform image display with little color variation due to the observation angle.

### BRIEF DESCRIPTION OF DRAWINGS

FIG. 1 is a graph showing a horizontal light distribution characteristic when single-color display is performed by a TN liquid crystal display apparatus;

FIG. 2 is a graph showing a single-color light distribution characteristic for the backlight of the display apparatus in FIG. 1;

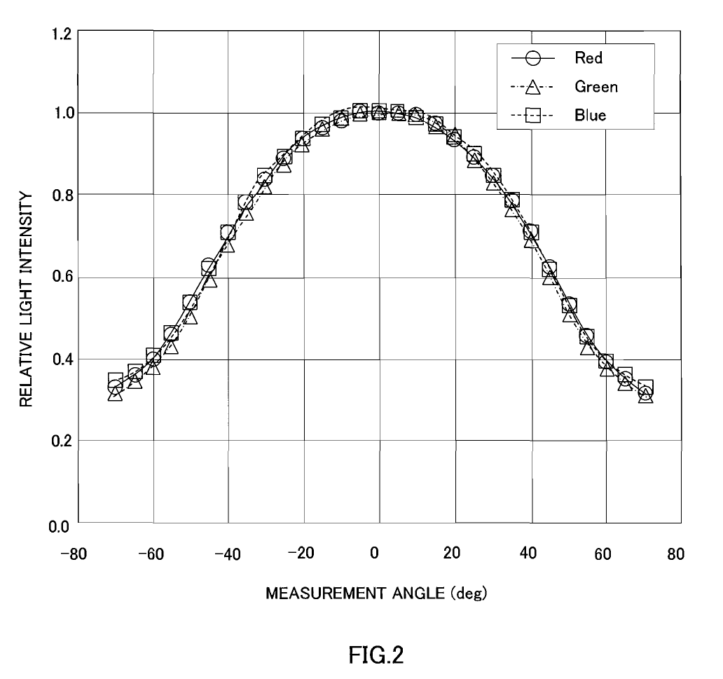

FIG. 3 is a schematic diagram showing the state of color shift occurrence when a liquid crystal panel is illuminated by a general light source with no wavelength dispersion;

FIG. 4 is a drawing showing the color shift of a white display of a liquid crystal display apparatus according to the observation angle, plotted as a chromacity locus on a CIE chromacity diagram;

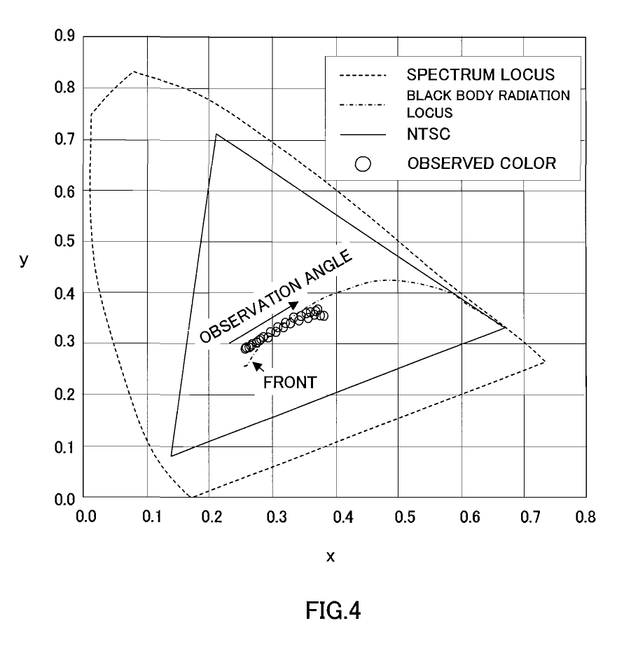

FIG. 5 is a graph showing the observation angle color shift of a liquid crystal display apparatus as a relationship between the observation angle and measured color temperature;

FIG. 6 is a cross-sectional diagram showing the configuration of Embodiment 1 of a liquid crystal display apparatus of the present invention;

FIG. 7A is a graph showing the wavelength dependency of the refractive index of PMMA and MS, and FIG. 7B is a graph showing the wavelength dependency of the relative refractive power (α refractive index difference) with PMMA, MS, and air media-combinations;

FIG. 8 is a graph showing the observation angle dependency of the color temperature of transmitted light when prototype diffusers are illuminated by white parallel light;

FIG. 9 is a graph showing the correlation between product Δn·d of refractive index difference Δn1 for diffusion particles and the base material of a prototype diffuser and diffusion particle average particle diameter d1 and color temperature shift (illumination→⅓ brightness attenuation angle);

FIG. 10 is a graph showing the liquid crystal display apparatus color shift reduction effect due to wavelength dispersive illumination;

FIG. 11 is a graph showing a vertical light distribution characteristic when single-color display is performed by a TN liquid crystal display apparatus;

FIG. 12 is a perspective view showing the configuration of an illumination section according to Embodiment 2 of a liquid crystal display apparatus of the present invention;

FIG. 13 is a cross-sectional diagram showing the configuration of an illumination section according to Embodiment 2 of a liquid crystal display apparatus of the present invention; and

FIG. 14 is a drawing showing an example of a matrix-type liquid crystal display apparatus.

### BEST MODE FOR CARRYING OUT THE INVENTION

Embodiments of the present invention will now be described with reference to the accompanying drawings.

### Embodiment 1

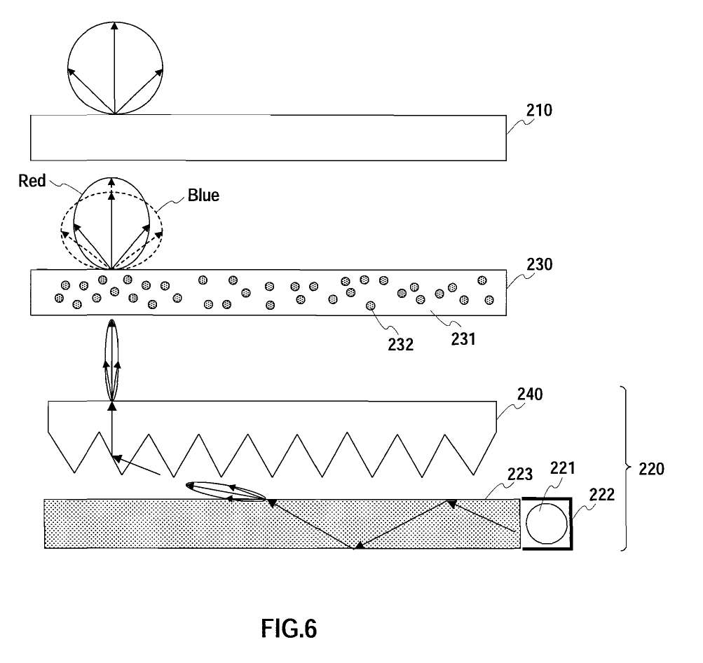

FIG. 6 is a cross-sectional diagram showing Embodiment 1 of a liquid crystal display module of the present invention. The liquid crystal display module is configured so that directional light from planar light source 220 having directivity in the normal direction of the liquid crystal display module is diffused by wavelength dispersive diffusion sheet 230 and illuminates liquid crystal panel 210.

Light from cold cathode ray tube 221 has its emission area regulated into linear form through the action of reflector 222, and is made incident from an end surface of light guide plate 223. Light incident from the end surface is propagated toward the end surface opposite the incident end while being repeatedly fully reflected between two opposing main surfaces.

A fine diffusion element that performs fine diffusion of light is provided in a localized fashion on one of the main surfaces of light guide plate 223, and light incident on part of this fine diffusion element departs from the full-reflection condition and is emitted. At this time, the size and density of the fine diffusion element are set appropriately so that emission from the entire surface of the light guide plate is performed with approximately uniform light intensity.

As the emitted light is only just outside the full-reflection condition due to fine diffusion, it is emitted at an angle nearly parallel to the main surface. While maintaining the directivity of that light, prism sheet 240 converts the main directivity direction to a normal direction relative to the light guide plate.

Wavelength dispersive diffusion sheet 230 diffuses the above light having strong directivity (directional light) by refracting it, and converts it to illumination light with a wide light distribution characteristic. At this time, setting is performed so that light of shorter wavelength is refracted and diffused more strongly.

As a result, short-wavelength blue light is diffused relatively widely (as indicated by dotted lines in the drawing), and long-wavelength red light is diffused relatively narrowly (as indicated by solid lines in the drawing). As a result, liquid crystal panel 210 is illuminated by wavelength dispersive illumination having wavelength dispersion in its light distribution characteristic, whereby a reddish tint is strong in the vicinity of the frontal direction, and a bluish tint is strong in a wide-angle direction.

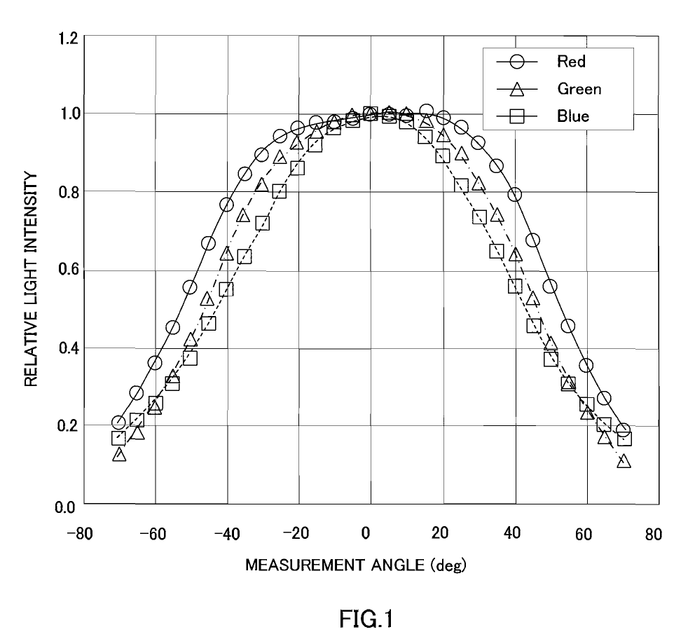

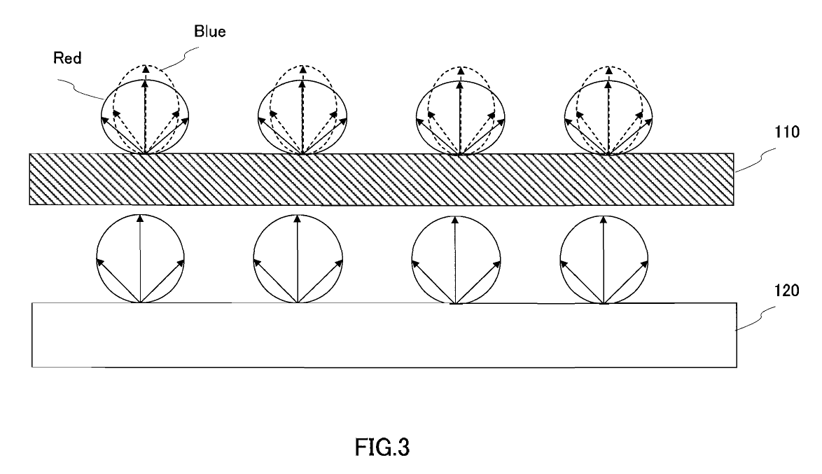

Liquid crystal panel 210 has wavelength dependency whereby transmittance for incident illumination light differs according to both the incident angle and wavelength (R, G, B). As shown in FIG. 1 and FIG. 3, liquid crystal panel 210 has high transmittance for relatively short-wavelength light for light incident in the normal direction (measurement angle of 0 degrees), and high transmittance for relatively long-wavelength light for light incident at a wide angle. In other words, the light intensity of emitted light for illumination light incident from the normal direction tends to be greatest when the measurement angle is 0 degrees, and light intensity tends to fall as the measurement angle increases (incident angle dependency of transmittance). Also, light intensity differs according to the measurement angle and wavelength of emitted light (wavelength dependency). The wavelength dependency of the liquid crystal panel has a characteristic whereby a relatively longer wavelength is transmitted as the measurement angle increases when directional light is incident in the normal direction. There is consequently a tendency for a bluish tint to appear when viewing from directly in front, and for a reddish tint to appear when observing from a wide angle. The above-described wavelength dispersive illumination lessens the wavelength dependency of liquid crystal panel 210. As a result, image display with little color variation due to observation direction becomes possible.

Wavelength dispersive diffusion sheet 230, which is characteristic of the present invention, will now be described in detail as an example.

Wavelength dispersive diffusion sheet 230 has wavelength dependency. The wavelength dependency of wavelength dispersive diffusion sheet 230 has a characteristic that is the reverse of the wavelength dependency of the liquid crystal panel in the visible light wavelength region. The wavelength dependency of wavelength dispersive diffusion sheet 230 has a characteristic whereby illumination light is diffused more widely the shorter the wavelength. Therefore, illumination light transmitted through wavelength dispersive diffusion sheet 230 tends to have a reddish tint when viewed from the front and a bluish tint when observed from a wide angle. Giving wavelength dispersive diffusion sheet 230 a characteristic that is the reverse of that of liquid crystal panel 210 means that the wavelength dependency of wavelength dispersive diffusion sheet 230 lessens the wavelength dependency of the liquid crystal panel. This enables the occurrence of color unevenness due to the observation angle to be reduced.

In wavelength dispersive diffusion sheet 230 base material 231, which is of transparent material, diffusion particles 232 (light diffusers) of a material having a different refractive index from that of base material 231 are dispersed in the thickness direction, and light is refracted a plurality of times by refraction at the interface between the two. As a result, incident light is diffused, and diffused light is emitted. That is to say, wavelength dispersive diffusion sheet 230 refracts incident light a plurality of times, and emits incident light to which wavelength dependency has been imparted. Product Δn1·d1 of difference Δn1 between the refractive index of diffusion particles 232 and the refractive index of base material 231 and diffusion particle average particle diameter d1 is set to approximately 0.1 μm. The average particle diameter is measured using a Coulter counter method.

If light is simply to be diffused, minute projections and depressions may be provided on the surface of a transparent sheet, as with frosted glass. However, if refraction at the interface with air is used in this way, it is difficult to obtain sufficiently great wavelength dependency to correct the kind of characteristic shown in FIG. 1.

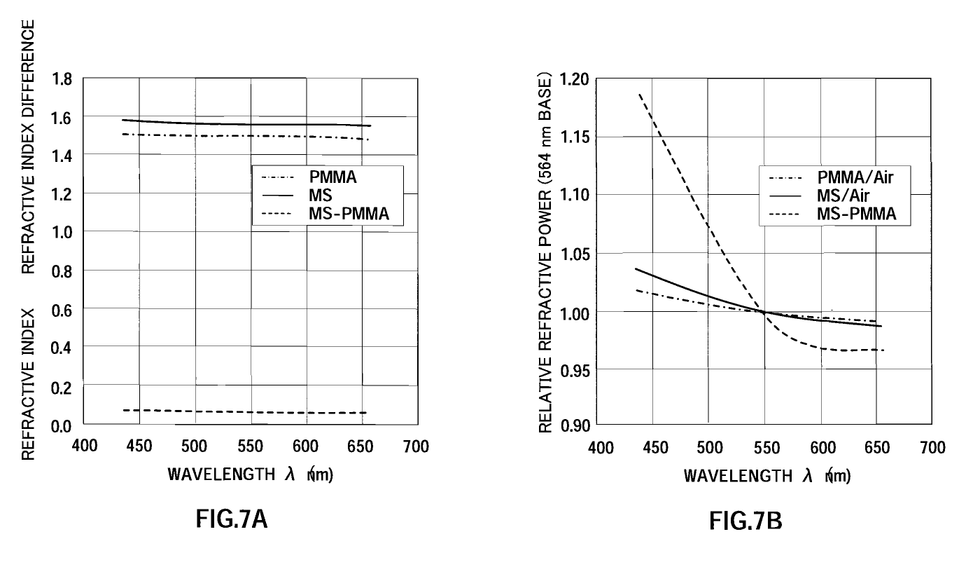

FIG. 7A is a graph showing the wavelength dependency of the refractive index of general PMMA (acrylic) and MS (a copolymer of acrylic and styrene) as a transparent resin material. In FIG. 7A, the dash-dot line indicates the refractive index of PMMA, the solid line indicates the refractive index of MS, and the dotted line indicates the refractive index of PMMA and MS. The horizontal axis represents wavelength, and the vertical axis represents the refractive index and refractive index difference. As shown in FIG. 7A, the refractive index is not fixed, but is wavelength-dependent (this kind of wavelength dependency phenomenon is called wavelength dispersion). With general optical materials, there is a tendency for the refractive index to be higher the shorter the wavelength. In other words, the shorter the wavelength, the more widely illumination light is diffused. As absolute refractive power is small at the interface between transparent resin materials, a plurality of refractions are necessary. A method whereby diffusion particles 232 are dispersed in the thickness direction in base material 231 is effective for this purpose.

When light is incident from a particular medium onto another medium with a different refractive index, refraction occurs at the interface in accordance with Snell's law, and the refractive power is proportional to the refractive index difference of the two media.

FIG. 7B is a graph showing the wavelength dependency of refractive power when above PMMA and MS are refracted at the interface with air (refractive index 1 irrespective of the wavelength), and at the interface of PMMA and MS. In FIG. 7B, the dash-dot line indicates relative refractive power of PMMA and air, the solid line indicates relative refractive power of MS and air, and the dotted line indicates relative refractive power of PMMA and MS. The horizontal axis represents wavelength, and the vertical axis represents relative refractive power. The vertical axis shows relative values with the refractive index difference normalized at a value for a 546 nm measurement wavelength.

As shown here, wavelength dispersion is significantly greater for refraction at the PMMA/MS interface than for refraction at the PMMA/air or MS/air interface. Implementation of diffusion with large wavelength dispersion can therefore be expected for comparatively short wavelengths by using refraction at an interface of the two.

Here, since the refractive index difference of the two is small, it is difficult to perform adequate diffusion with a 2-layer structure of PMMA and MS with one surface having projections and depressions as the interface, as in the case of an interface with air. Thus, opportunities for refraction are increased by using one material as a medium and dispersing particles of the other material therein.

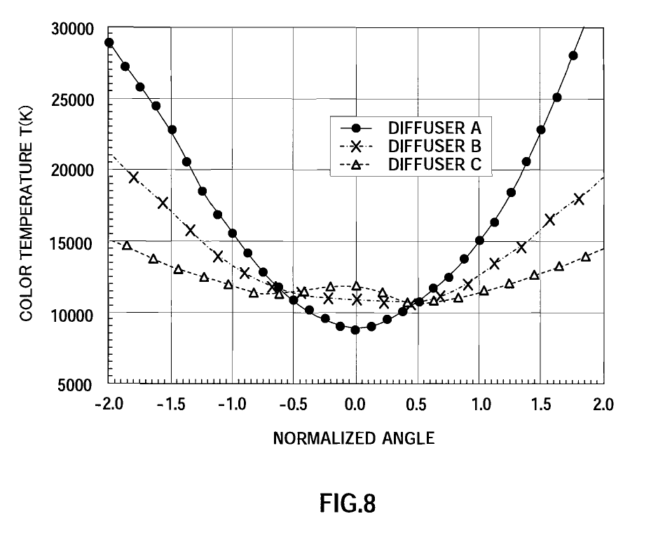

However, even when using the same kind of material composition, different wavelength dependency is shown according to the dispersing particle diameter and refractive index difference setting. FIG. 8 is a graph showing the results of measuring diffused light when white parallel light is made incident on three kinds of diffuser, A, B, and C, that all have PMMA as a base material in which diffusion particles of MS resin are dispersed in the thickness direction. The horizontal axis represents a normalized angle whereby the observation angle is normalized at a ⅓ brightness attenuation angle, and the vertical axis represents color temperature. The reason for showing relative values normalized at a ⅓ brightness attenuation angle instead of absolute values of the observation angle is to eliminate the influence of the magnitude of diffusion.

In wavelength dispersion of the PMMA/MS interface refractive power shown in FIG. 7B, since diffusion is wider the shorter the wavelength, in the frontal direction a relatively reddish tint appears and therefore the color temperature is low, and a bluish tint appears and the color temperature rises as the angle increases. If calculation is performed with the addition of the white light spectrum used in the characteristic in FIG. 7B, the measured values of diffuser A are approximately matched.

With diffuser B and diffuser C, it is thought that a diffusion mechanism different from geometrical optical diffusion—namely, “diffusion through the occurrence of refraction based on Snell's law at the interface between a medium and diffusion particle”—operates, and the above geometrical optical wavelength dispersion characteristic is canceled out.

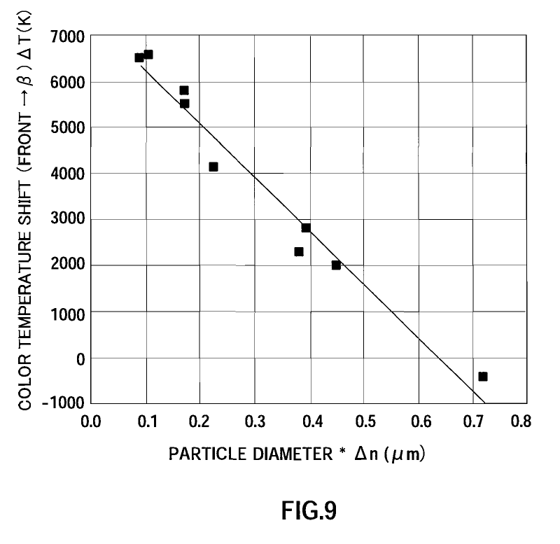

We carried out experimental fabrication of diffusion sheets using various diffusion particles with different average particle diameters, and the evaluation results showed a strong correlation between product Δn1·d1 of average particle diameter d1 and refractive index difference Δn1, and a wavelength dispersion characteristic. This is illustrated in FIG. 9.

In FIG. 9, the horizontal axis shows the product of the average particle diameter of diffusion particles used in a prototype diffusion sheet and the refractive index difference with respect to the medium, and the vertical axis represents the difference between the frontal direction color temperature of transmitted light and the color temperature at a ⅓ brightness attenuation angle (color temperature shift) when white parallel light is incident on a prototype diffusion sheet, showing the degree of wavelength dispersion of diffusion.

As can be seen from FIG. 9, the smaller the product of average particle diameter and refractive index difference, the more pronounced is the wavelength dispersion characteristic in diffusion. In general use requiring a characteristic that is not wavelength-dependent, it is desirable for product Δn1·d1 of average particle diameter d1 and refractive index difference Δn1 to be in the vicinity of 0.6 μm, but to obtain a pronounced wavelength dispersion characteristic a figure of 0.3 μm or less, and preferably in the vicinity of 0.1 μm, is desirable.

The above trial fabrication evaluation was carried out using PMMA, styrene, and MS resin that is a copolymer thereof, as materials, but the refractive index and wavelength dispersion tendencies of a general optical resin including polycarbonate or the like are fixed, and the Abbe number relation to the refractive index lies approximately on one straight line for any material. Therefore, the correlation shown in FIG. 9 holds not only for styrene/acrylic type materials, but on the whole for optical materials in general.

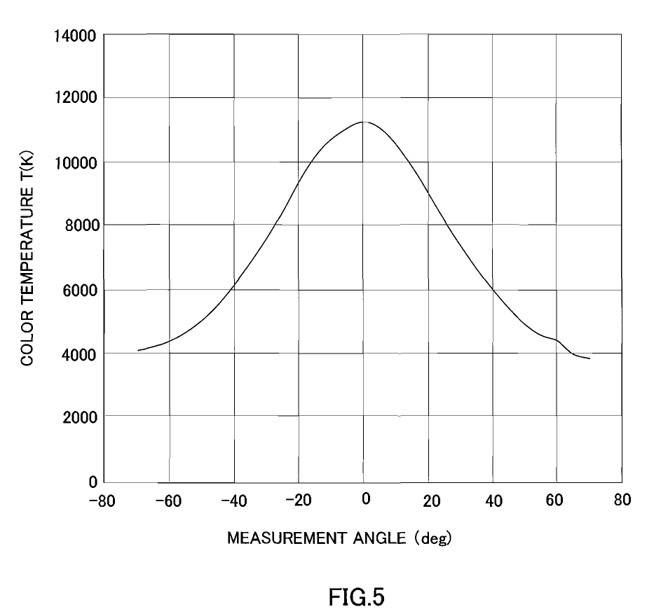

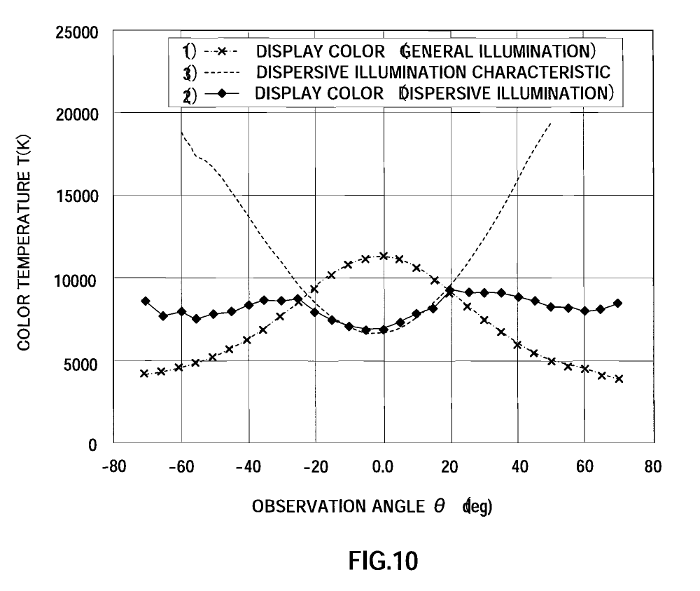

Wavelength dispersive illumination was performed using diffuser A with a setting of Δn1·d1=0.1 μm on a liquid crystal panel showing the kind of characteristic in FIG. 5 when general illumination with no wavelength dispersion is performed, and liquid crystal panel transmitted light was measured. The measurement results are shown in FIG. 10. In FIG. 10, the horizontal axis represents the observation angle, and the vertical axis represents the color temperature. The notation in FIG. 10 is as follows:
(1) Liquid crystal panel transmitted light under general illumination
(2) Wavelength dispersive illumination light using a wavelength dispersive diffusion sheet
(3) Liquid crystal panel transmitted light when above (1) liquid crystal panel is illuminated using above (2) wavelength dispersive illumination light

As can be seen from FIG. 10, performing wavelength dispersive illumination greatly reduces color variation due to the observation angle.

Thus, with a liquid crystal display apparatus of the present invention, a liquid crystal display module with little color variation due to the observation angle can be implemented by correcting (lessening) a wavelength dispersion characteristic of a liquid crystal panel without using a hologram sheet, which is a special and comparatively expensive member.

In the above embodiment, a combination of light guide plate and downward-facing prism sheet is used to obtain a highly directive planar light source, but the present invention is not limited to this.

Various methods of obtaining a highly directive planar light source have been proposed, including, for example, a method whereby directivity is imparted to emitted light using an upward-facing prism sheet and some of the light is reflected toward the light guide plate and reused, and a method whereby an approximately point-source LED is used as a light source, this is positioned at an angle of the light guide plate, and a very narrow structure is positioned so that some of the light propagated via the light guide plate is emitted in a normal direction with respect to the main surface of the light guide plate, and these methods may also be used.

In the above embodiment, resin is used as the base material of the wavelength dispersive diffusion sheet and the material of the light diffusion particles, but the present invention is not limited to this, and a glass material may also be used for one or the other.

### Embodiment 2

Depending on the kind of liquid crystal panel, a liquid crystal panel may have anisotropy whereby wavelength dependency differs in the horizontal direction and in the vertical direction. Within the scope of our evaluation, we found the wavelength dependency of vertically-aligned liquid crystal to be approximately isotropic, and the wavelength dependency of TN liquid crystal to be highly anisotropic.

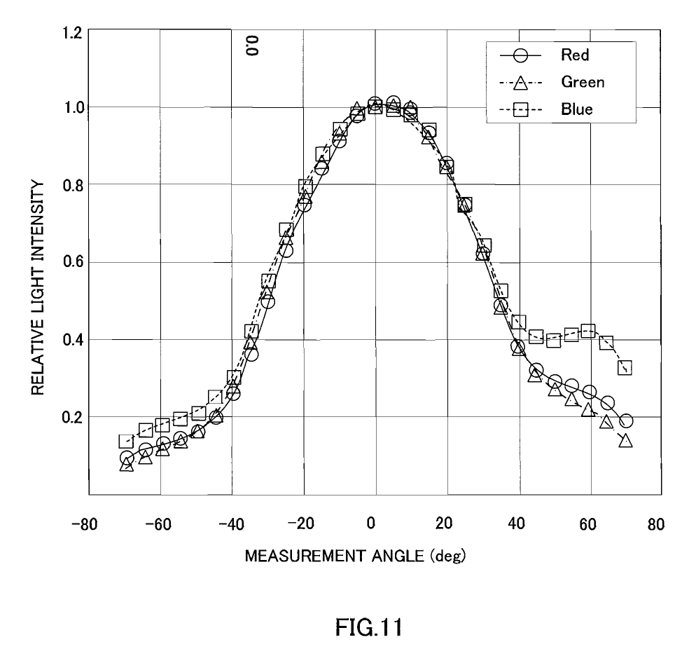

As stated above, FIG. 1 shows the results of measuring a light distribution characteristic when the single colors red, blue, and green are displayed by a liquid crystal display apparatus that uses TN liquid crystal, where the observation angle measurement direction is the horizontal direction with the liquid crystal display apparatus positioned in a normal usage state. FIG. 11 shows the results of similar measurements when the observation angle measurement direction is the vertical direction. As can be seen, for the vertical direction, a significant wavelength dispersion characteristic is not shown within a range of [practical viewing angle range ±40°]. Compared with the horizontal-direction light distribution characteristic shown in FIG. 1, the vertical-direction light distribution characteristic shows a marked drop in transmittance as the measurement angle increases (light distribution characteristic anisotropy). This light distribution characteristic anisotropy is a characteristic of the backlight.

With illumination by means of a backlight, there is no wavelength dispersion either horizontally or vertically, and above-described anisotropy of the wavelength dispersion characteristic of liquid crystal display apparatus light distribution is a liquid crystal panel characteristic.

In this case, when wavelength dispersive illumination such as shown in radio communication system 10 is performed isotropically, a liquid crystal panel wavelength dispersion characteristic can be corrected and a color shift reduced for the horizontal direction, but for the vertical direction, a color shift that does not occur with normal illumination with no wavelength dispersion is newly created.

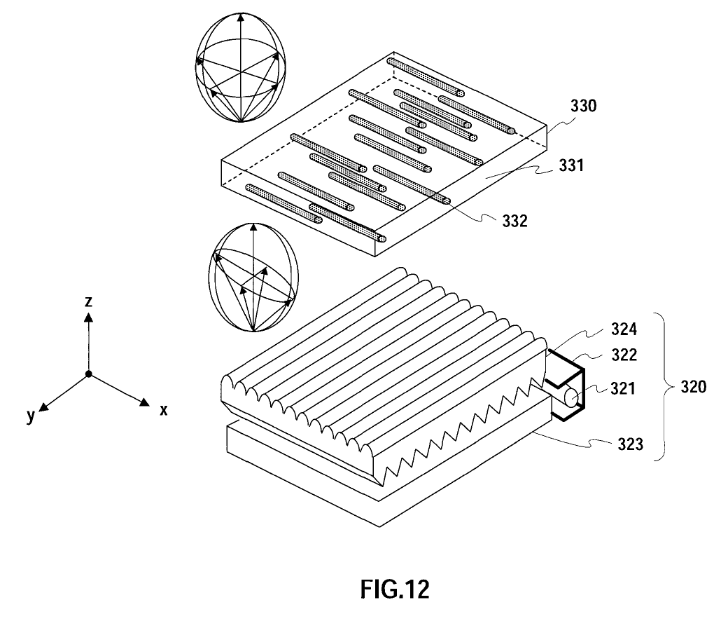

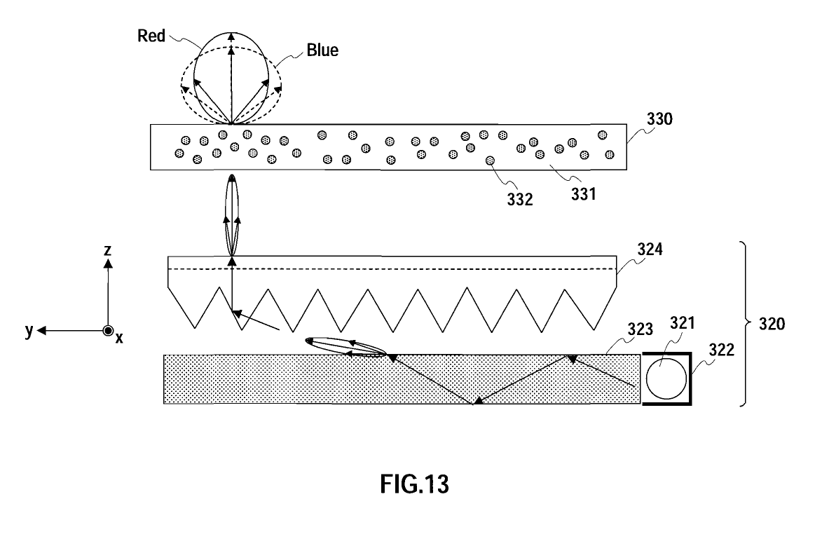

Embodiment 2 of the present invention applies to a liquid crystal display module using a liquid crystal panel with anisotropy in its wavelength dispersion characteristic as described above, and its configuration is shown in FIG. 12 and FIG. 13.

In a similar way to Embodiment 1 shown in FIG. 6, directive light source 320 is composed of cold cathode ray tube 321, reflector 322, light guide plate 323, and prism sheet 324. A difference from the configuration in FIG. 6 is that a lenticular lens array that diffuses light in the x direction in FIG. 12 is provided on the emitting side of prism sheet 324. As a result, light with high directivity in the y direction and large diffusion in the x direction is emitted. Since diffusion in the x direction is caused by refraction by the lenticular lens surface at the interface between the air and base material, incident light can be diffused in a state in which there is little wavelength dispersion, as described above. Light distribution characteristic anisotropy can be lessened by increasing diffusion in the x direction of the liquid crystal panel. If it is wished to further increase x-direction diffusion, a plurality of lenticular lens array layers may be used. Using a plurality of lenticular lens array layers enables diffusion to be increased with a high degree of precision.

Reference number 330 denotes a wavelength dispersive diffusion sheet having anisotropy, in which fine fibers 332 (light diffusers) are dispersed in base material 331 oriented so that their lengthwise direction is the x direction. The shape of the interface between fine fibers 332 and base material 331 is circular in cross-section parallel to the yz plane, and planar in cross-section parallel to the xz plane, so that light undergoes refraction only in the y direction.

There is wavelength dependency in difference Δn2 between the refractive index of base material 331 and the refractive index of fine fibers 332, and product Δn2·d2 of Δn2 and fine fiber average diameter d2 is set to approximately 0.1 μm. In general use requiring a characteristic that is not wavelength-dependent, it is desirable for product Δn2·d2 of average diameter d2 and refractive index difference Δn2 to be in the vicinity of 0.6 μm, but to obtain a pronounced wavelength dispersion characteristic a figure of 0.3 μm or less, and preferably in the vicinity of 0.1 μm, is desirable.

By means of the above configuration, illumination light can be obtained for which wavelength dispersion is small in the x direction and wavelength dispersion is large in the y direction, and a liquid crystal display module can be implemented that effectively illuminates a liquid crystal panel with anisotropy in wavelength dispersion and has a small color shift with respect to any observation angle. Furthermore, anisotropy of a backlight light distribution characteristic can be corrected (lessened).

In the above embodiment, a light source with anisotropy in directivity and a diffusion sheet having anisotropy in wavelength dispersion are used to perform illumination with anisotropy in wavelength dispersion, but the present invention is not limited to this, and it is also possible for light to be transmitted through an anisotropic wavelength dispersive diffusion sheet that diffuses light in only one direction using a highly directional light source, and then perform anisotropic diffusion with no wavelength dispersion with a lenticular lens array sheet or the like.

Thus, according to a configuration of the present invention, a liquid crystal display apparatus can be implemented that corrects a wavelength dispersion characteristic of incident angle dependency of liquid crystal panel transmittance, and has high display quality with little color variation due to the observation angle, by means of a simple method without using a plurality of hologram sheets.

<Matrix-Type Liquid Crystal Display Apparatus>

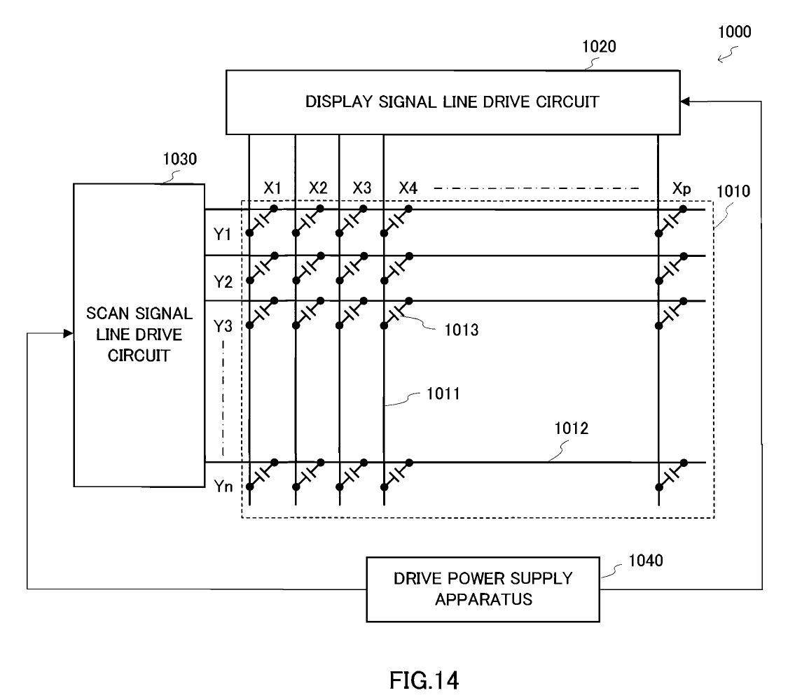

FIG. 14 shows an example of a matrix-type liquid crystal display apparatus. This matrix-type liquid crystal display apparatus 1000 is composed of matrix-type liquid crystal display module 1010, display signal line drive circuit 1020, and scan signal line drive circuit 1030. Matrix-type liquid crystal display module 1010 is composed of liquid crystal panel 210, planar light source 220 that illuminates liquid crystal panel 210 from its back surface, and wavelength dispersive diffusion sheet 230 that is located between liquid crystal panel 210 and planar light source 220. Display control circuitry of the present invention corresponds to display signal line drive circuit 1020 and scan signal line drive circuit 1030. Driving display signal line drive circuit 1020 and scan signal line drive circuit 1030 enables the matrix-type liquid crystal display apparatus to display an image.

In liquid crystal panel 210, p display signal lines 1011 and n scan signal lines 1012 are arranged in the form of a matrix, and a liquid crystal display element 1013 is formed between a signal electrode and scan electrode at each intersection point. Display signal line drive circuit 1020 outputs display signals (drive signals) via display signal lines 1011. Scan signal line drive circuit 1030 outputs scan signals via scan signal lines 1012. Liquid crystal display elements 1013 are driven by the potential difference between a display signal and a scan signal. Drive power supply apparatus 1040 supplies power to display signal line drive circuit 1020 and scan signal line drive circuit 1030.

Display signal line drive circuit 1020 and scan signal line drive circuit 1030 are formed from liquid crystal drive controller integrated circuits (ICs).

As the drive method of this matrix-type liquid crystal display apparatus 1000 by means of display signal line drive circuit 1020 and scan signal line drive circuit 1030, there is a time-division drive method whereby scan signals are output sequentially to scan signal lines 1012, and liquid crystal drive is performed by applying a selection voltage/non-selection voltage (scan signal) from display signal line 1011 according to selection/non-selection data for liquid crystal display element 1013 on scan signal line 1012 while that scan signal line 1012 is selected. With this time-division drive method, setting is performed so that the number obtained by dividing vertical synchronization signal cycle T by the period during which one scan signal line is selected is the same as number of scan signal lines n.

Since driving liquid crystal with a direct current causes deterioration of the liquid crystal itself, lowering display quality and significantly affecting operational life, liquid crystal requires alternating current drive, and in the above general matrix-type liquid crystal display apparatus 1000 time-division drive method, alternation is performed by driving with a polarity inversion (alternation) signal whose polarity is inverted each time natural number k (smaller than number of scan signal lines n) scan signal lines 1012 are selected.

The disclosure of Japanese Patent Application No.2006-113145, filed on Apr. 17, 2006, including the specification, drawings and abstract, is incorporated herein by reference in its entirety.

### INDUSTRIAL APPLICABILITY

The present invention enables a video display having little color variation due to the observation angle to be implemented with a small number of parts and a simple configuration, and can contribute to improving the display performance of a video display apparatus requiring high-quality video, such as a liquid crystal TV, liquid crystal monitor, or the like.

1. A liquid crystal display module comprising:
a liquid crystal panel having wavelength dependency whereby transmittance for incident illumination light differs according to both an incident angle and a wavelength of the illumination light;
a light source that illuminates the liquid crystal panel from a back surface; and
a wavelength dispersive diffusion sheet that is located between the liquid crystal panel and the light source and has wavelength dependency,
wherein the wavelength dispersive diffusion sheet has a characteristic whereby the wavelength dependency lessens wavelength dependency of the liquid crystal panel.

2. The liquid crystal display module according to claim 1, wherein wavelength dependency of the wavelength dispersive diffusion sheet has an opposite characteristic of wavelength dependency of the liquid crystal panel in a visible light wavelength region.

3. The liquid crystal display module according to claim 1, wherein the wavelength dispersive diffusion sheet has a characteristic whereby the illumination light diffuses more widely the shorter the wavelength.

4. The liquid crystal display module according to claim 1, wherein the wavelength dispersive diffusion sheet has, within a transparent base material, light diffusers having a refractive index different from a refractive index of the base material, dispersed in a thickness direction of the transparent base material, causes refraction to be performed a plurality of times, imparts the wavelength dependency, and emits the illumination light.

5. The liquid crystal display module according to claim 1, wherein the wavelength dispersive diffusion sheet has, dispersed within a transparent base material, light diffusion particles having a refractive index different from a refractive index of the base material, and refractive index difference Δn of the base material and the light diffusion particles differs according to wavelength, refractive index difference Δn being larger the shorter the wavelength.

6. The liquid crystal display module according to claim 5, wherein product Δn1·d1 of refractive index difference Δn1 of the base material and light diffusion particles of the wavelength dispersive diffusion sheet and average particle diameter d1 of the light diffusion particles satisfies a relational expression Δn1·d1≦0.3 μm.

7. The liquid crystal display module according to claim 1, wherein:
the liquid crystal panel has anisotropy whereby the wavelength dependency differs in a horizontal direction and in a vertical direction;
there is anisotropy in at least one of directivity of the light source, a diffusion characteristic of the wavelength dispersive diffusion sheet, or wavelength dependency of the wavelength dispersive diffusion sheet, and the liquid crystal panel is illuminated by illumination light having anisotropy in wavelength dependency; and
anisotropy of wavelength dependency imparted to the illumination light is set so as to lessen anisotropy of wavelength dependency of the liquid crystal panel.

8. The liquid crystal display module according to claim 7, wherein:
the light source has directivity in a specific direction and performs planar light emission having anisotropy with relatively large diffusion in a direction orthogonal thereto; and
the wavelength dispersive diffusion sheet shows large diffusion in the specific direction and has wavelength dependency in that diffusion.

9. The liquid crystal display module according to claim 8, wherein, in the wavelength dispersive diffusion sheet, within a transparent base material, fine fibers that are approximately circular in cross-section and have a refractive index different from a refractive index of the base material are dispersed oriented so that their lengthwise directions approximately coincide.

10. The liquid crystal display module according to claim 9, wherein product Δn2·d2 of refractive index difference Δn2 of the base material and the fine fibers of the wavelength dispersive diffusion sheet and average diameter d2 of the fine fibers satisfies a relational expression Δn2·d2≦0.3 μm.

11. A wavelength dispersive diffusion sheet that has wavelength dependency whereby transmittance for incident illumination light differs according to both an incident angle and a wavelength of the illumination light, and can be installed on a liquid crystal panel having anisotropy whereby the wavelength dependency differs in a horizontal direction and in a vertical direction,
wherein, within a transparent base material, fine fibers that are approximately circular in cross-section and have a refractive index different from a refractive index of the base material are dispersed oriented so that their lengthwise directions approximately coincide.

12. The liquid crystal display module according to claim 11, wherein product Δn2·d2 of refractive index difference Δn2 of the base material and the fine fibers and average diameter d2 of the fine fibers satisfies a relational expression Δn2·d2≦0.3 μm.

13. A liquid crystal display apparatus comprising:
a liquid crystal panel having wavelength dependency whereby transmittance for incident illumination light differs according to both an incident angle and a wavelength of the illumination light;
a light source that illuminates the liquid crystal panel from its back surface;
a wavelength dispersive diffusion sheet that is located between the liquid crystal panel and the light source and has wavelength dependency, and whose wavelength dependency is set so as to lessen wavelength dependency of the liquid crystal panel; and
a display control circuit that drives the liquid crystal panel and displays an image.

14. The liquid crystal display apparatus according to claim 13, wherein the wavelength dispersive diffusion sheet has, within a transparent base material, light diffusers having a refractive index different from a refractive index of the base material, dispersed in a thickness direction of the transparent base material, causes refraction to be performed a plurality of times, imparts wavelength dependency, and emits illumination light.

15. The liquid crystal display apparatus according to claim 13, wherein light diffusers of the wavelength dispersive diffusion sheet are light diffusion particles, or fine fibers that are approximately circular in cross-section and are dispersed oriented so that their lengthwise directions approximately coincide.
